(19) United States
(12) Patent Application Publication
(10) Pub. No.: US 2020/0296989 A1
(43) Pub. Date: Sep. 24, 2020

(54) COMPOSITION OR POWDER MIXTURE FOR PREPARING DECORATIVE SUGAR PASTE (FONDANT, SLIM FONDANT ORNAMENTS, FLOWERS, ELASTIC PASTE, ETC) FOR CAKE ICING AND SIMILARS AND DECORATIVE SUGAR PASTE OBTAINING METHOD

(71) Applicant: ICEBERG INDÚSTRIA E COMÉRCIO LTDA, Barueri (BR)

(72) Inventor: Marcio José BIASOTTO, Barueri (BR)

(21) Appl. No.: 16/821,482

(22) Filed: Mar. 17, 2020

(30) Foreign Application Priority Data
Mar. 18, 2019 (BR) 10 2019 005212 0

(51) Int. Cl. A23G 3/34; A23G 3/42; A23G 3/40; A21D 13/28; A21D 13/24

(52) U.S. Cl. CPC A23G 3/343; A23G 3/346; A23G 3/42; A23V 2002/00; A21D 13/28; A21D 13/24; A23G 3/40

(57) ABSTRACT

The present invention patent deals with the powder composition of decorative paste of the type ‘Fondant’ to cover cakes and the like such as ‘cupcakes’, mini-cakes, biscuit decoration or other types of decorated treats where, notably, said innovative composition powder allows the user to prepare the decorative paste in the desired proportion according to the decoration to be carried out, and, because it is said to be a powder composition, it has a much longer shelf life than those products that are ready for use on the market or homemade version, ensuring greater practicality in handling and resistance to moisture, thus enabling better quality of the resulting ‘Fondant’. The powder composition for decorative paste has the following formulation for each 1 kg: 60 to 78% refined sugar; 10 to 20% starch; 5 to 10% fat; 1 to 5% gum; 0.1 to 0.5% of preservatives; 9 to 16% emulsifiers; 0.1 to 1% of artificial colors and aromas identical to natural; 0.1 to 1% anti-humectant. The decorative paste powder composition has a moisture content of 3% to 5%.

### FIELD OF THE INVENTION

The present invention patent deals with the powder composition for preparing decorative sugar paste of the ‘Fondant’ type or for pastilles, flowers, elastic batter, etc. to cover cakes and similar items such as ‘cupcakes’, mini-cakes, cookie decoration or other types of decorated treats where, notably, this innovative powder composition allows the user to prepare the decorative paste in the desired proportion according to the decoration to be made, as well as, for being said powder composition, it has a much longer shelf life than those products that are ready on the market, ensuring greater practicality in handling and resistance to humidity, thus enabling better quality of the resulting ‘Fondant’.

### BACKGROUND OF THE INVENTION

The current confectionery market has numerous types of decorations for cakes and the like such as ‘Fondant’, ‘buttercream’, ‘Pouring Fondant’, ‘royal icing’, each of which has different characteristics, advantages and disadvantages, in relation to each other. For example, the coating obtained from butter and icing sugar, known as ‘buttercream’, has a creamy consistency and is specific to work with icing nozzles, allowing delicate decorations. However, the disadvantage of the coverage lies in the fact that it is impacted by temperature and humidity, in addition to making transportation difficult, since the finish is delicate.

Royal icing is made from egg whites and powdered sugar. When preparing it, it is more fluid and consistent, very similar to the ‘buttercream’ topping, but after drying, the ‘royal icing’ hardens, looking like a meringue. The disadvantage lies in the fact that it can generate cracks, so it is not ideal for covering large surfaces like an entire cake.

If the consumer chooses a decoration not only focused on details, but also as complete or partial coverage of the cake or candy that presents greater durability, stability, and mainly, can be modeled, they can use the cover known as ‘Fondant’ or ‘Rolling Fondant’ which is made up of powdered sugar, corn glucose syrup and water. The ‘Fondant’ is very popular because it is used to cover the cake and leaves it as a canvas ready to be decorated.

Likewise, there is a type of ‘Fondant’ in liquid form on the market, also called ‘Pouring Fondant’ where the composition is similar to ‘Rolling Fondant’ and used to cover cakes or ‘cupcakes’ and, once poured, it hardens, finishing the decoration.

The drawback of the aforementioned ‘Pouring Fondant’ lies in the fact that it also has an expiration date (average 6 months), as well as the consumer must maintain precautions when storing fondant ‘leftovers’ so that it does not harden before the use.

Conventionally, the ‘Fondant’ is marketed ready for use, that is, its basic formulation includes refined sugar, vegetable fat, vegetable gums and glucose syrup, in addition to CMC Stabilizer and Preservative E 300. Flavoring is artificial. It generally constitutes a block of ‘Fondant’ which is available in packages of 500 g, 750 g and 1 kg, 2 kg and up to 4.5 kg, preferably in white, which can receive food coloring or can be made available in different colors, such as yellow, pink, blue, green and others. In order to be used, consumers must remove the desired quantity from the packaging and knead until it is malleable. The remaining of the dough must be stored for up to 15 days.

Another way for obtaining the ‘Fondant’ is through homemade preparation, very common for consumers. Powdered gelatin (unflavored), dissolved in heated water before use, fat and/or glucose from corn (or honey), almond essence (or other) and powdered sugar (sieved) that must be mixed and kneaded until the desired consistency is obtained. Once this is done, the dough or paste must be wrapped in plastic film (free from air) and packed in airtight jars and wait at least 24 hours for use. Thus, the set must be stored for up to 30 days and, if used, must be in its entirety as it does not contain preservatives. It can be colored with food coloring.

As it is packed in plastic film, it is difficult to see if the paste is elastic and homogeneous to work. In addition, if the consumer does not have practice to massage the product, they will not be able to interpret the appropriate state to work. In addition, if the consumer does not have practice to massage the product, they will not be able to identify the appropriate state to work considering homogeneity, elasticity, appearance, etc., so that they can cover, decorate and model it. If this procedure is not adequate, ‘fondant’ it will not perform at its best.

Either of the two versions—industrialized or homemade—of the ‘fondant’ is easy to model, thus allowing to obtain different shapes such as sculptures of characters, animals, among others, in addition to being able to be painted and guaranteeing the perfect coverage of cakes and the like. However, both the ‘paste’ supplied ready to use and the homemade one must be prepared for application, since its shape and consistency do not allow immediate application, needing to be massaged manually until when the dough is smooth, free of cracks and lumps, thus being ready to open to the desired thickness with the aid of a roller or laminator. Due to the need to massage the paste to the point of opening with a roller and/or laminator, in the ready-to-use form, it is generally rigid, the desired yield is often not achieved, as the consumer gets tired and does not reach the desired thickness.

The drawback lies in the fact that if the consumer has no practice in visualizing the adequate consistency, that is, ideal elasticity, the decoration and/or topping of the cake can be damaged, such as the appearance of cracks, thus impairing the ornamentation of the cake. Often, consumers who use the laminator to obtain decreased thicknesses, if attention is not paid, there is a risk of breaking the dough, which would require the massage to be started again.

Another drawback of the usual formats lies in the fact that the ready-to-use ‘Fondant’ is supplied with a certain amount of moisture or dry, making it necessary, during handling/massaging, to add other ingredients such as sugar, starch or fat to adjust the ideal point for the job.

Another issue is the fact that partial use of the fondant promotes the dryness of the leftovers, requiring storage in another package to prevent dryness.

Another drawback lies in the fact that the ‘Fondant’ supplied that is ready for use expires, in closed package, after twelve months, because due to humidity, the development of microbiological activity is possible. In addition, considering that at least 10% of the ready-to-use paste is water, and considering, for example, a packaged pack of 800 g, it is said that of ‘Fondant’, in fact, there is 720 g.

### ANALYSIS OF THE PRIOR ART

In research carried out in specialized databases, documents were found referring to the powder composition of decorative paste of the type ‘Fondant’ to cover cakes and the like, such as document No. CZ5282 (Drzatkova Terezia, 1996) whose composition consists of components suitable for food use and foresees 87 to 92% of weight of refined sugar, flour, 0.13% of a polysaccharide in a compound of glucose units linked in the molecule predominantly with ligands of glucose, where at least 90% and the molecular weight is in the range of 65000 to 75000 and from 4.87 to 7.87 by weight additives that are natural flavors, colorings and flavors suitable for food and characteristics for confectionery products with a moisture content up to 5%.

Document No. BR11.2015.006884-7 deals with a ‘Pouring Fondant’ comprising a sugar system consisting of a first non-crystalline phase and a second crystalline phase, in which the non-crystalline phase contains isomaltulose and sucrose and in which the crystalline phase contains isomaltulose; a process for producing it; use of ‘Pouring Fondant’ as icing, topping or filling for bakery products.

The aforementioned documents, despite belonging to the same field of application, that is, product preparation for confectionery decoration, are different from the present invention in question, as will be seen below, thus ensuring that it meets fully the legal requirements for patentability.

### OBJECTS OF THE INVENTION

The main object of the innovative composition of ‘Fondant’ in powder is to present a product that does not require massaging, since it is enough for the consumer to choose the volume of powder corresponding to the desired production, add hot water to the powder using a suitable doser, beat in an electric mixer for 2 minutes at speed 1, let it rest for 30 minutes and beat for 2 more minutes (one minute at speed 1 and the other minute at speed 2), thus being ready to be worked in roll or lamination until reaching the desired thickness.

Through the description above, the present invention achieves one of the greatest advantages, namely, the innovative powder composition, when adding hot water to obtain the dough, does not require physical effort.

Another substantial advantage is the way of presenting the product (powder) increasing its ‘shelf life’, thus eliminating the need for differentiated storage at the POS, since it can remain closed for eighteen months out of refrigeration and in case of leftover post preparation (opening of the packaging), storage in the packaging itself is enough, and it can be used when necessary within a maximum period of 30 days.

Another advantage lies in the fact that the composition of decorative powder paste does not contain moisture in its form of presentation, a fact that minimizes microbiological growth, certainly following the proper storage procedure. Thus, the powder composition is more resistant to humidity in the environment compared to competing products.

Another advantage lies in the fact that the decorative paste powder composition makes it possible to obtain a dough with a newly produced consistency, that is, constantly smooth.

The main and greatest advantage is related to the weight supplied to the consumer, as previously said, the ready-for-use ‘Fondant’ has 10% water, that is, it includes 720 g of product, in the present case of the composition powder, the fact that there is no water in its formulation, allows the consumer, when purchasing 800 g, will actually get 10% more product compared to the ‘ready-to-use paste’ on the market, that is, the consumer pays for what they take.

### DESCRIPTION OF THE INVENTION

With reference to the illustrated drawings, the present invention patent refers to a novel “POWDER COMPOSITION FOR PREPARING DECORATIVE SUGAR PASTE TO COVER CAKES AND THE LIKE, AND METHOD FOR OBTAINING SUGAR PASTE FOR DECORATION”, more precisely it is a powder composition of decorative paste of the type ‘Fondant’ or ‘rolling fondant’ to cover cakes and similar items such as cupcakes, mini-cakes, biscuit decoration or other types of decorated treats.

The composition for obtaining the decorative paste, object of the present patent, in powder presentation, presents the following formulation for every 1 kg: 60 to 78% of refined sugar; 10 to 20% starch; 5 to 10% fat; 1 to 5% gum; 0.1 to 0.5% of preservatives; 9 to 16% emulsifiers; 0.1 to 1% of artificial colors and aromas identical to natural; 0.1 to 1% anti-humectant. The decorative paste powder composition has a moisture content of 3% to 5%.

The starch in the powdered composition is preferably, but not limited to, corn or cassava starch.

The fat in the powdered composition is preferably, but not limited to, the hydrogenated vegetable fat from soybean powder.

The gum of the powdered composition is preferably, but not limited to, carboxymethylcellulose (CMC) and bovine gelatin.

An example of a preservative in the powder composition of the present patent can be, but not limited to, potassium sorbate.

An example of an emulsifier of the powder composition of the present patent can be, but not limited to, sodium stearoyl-2-lactyl-lactate.

An example of an anti-humectant used in the powder composition of the present invention is silicon dioxide.

The method for obtaining the decorative paste of the type ‘Fondant’ or ‘Rolling Fondant’ using the mechanical preparation (mixer) comprises the following steps:

a) Adding 10% humidity with the addition of boiling water at a temperature of 95° to 100° C. to the weight of the powder.

b) First mechanical mixing (mixer) of the weight of powder and water from step “a” for two minutes at low speed.

c) Remaining of the mixture from step “b” for one hour.

d) Second mechanical mixture (mixer) of the product from step “c” for one minute at low speed and another minute at medium/high speed.

Alternatively, the method for obtaining the decorative paste of the type ‘Fondant’ or ‘Rolling Fondant’ used by manual preparation occurs through the following steps:

a1) Adding 10% humidity with the addition of boiling water at a temperature of 95° to 100° C. to the weight of the desired powder.

b1) The first mixture must be made by kneading until the entire mixture is homogeneous.

c1) The product obtained from step ‘b1’ is put to rest for one hour.

d1) A second mixture is made by kneading until a smooth and homogeneous texture is obtained.

After the mechanical or manual mixing steps of the desired weight of the decorative paste powder composition with the volume of boiling water specified in the doser, the product is ready for use and can be laminated by roll or laminating apparatus in order to obtain plates to coat and decorate cakes and pies, make pastilles and modeling, as well as adding pigmentation with food coloring as necessary.

It is true that when the present invention is put into practice, modifications may be made, without implying departing from the fundamental principles that are clearly substantiated in the set of claims, thus understanding that the terminology used was not intended to limitation.

1. Powder composition for preparing decorative sugar paste to cover cakes and the like, and method for obtaining sugar paste for decoration, more precisely, a powder composition of decorative paste like ‘Fondant’ or ‘Rolling Fondant’ to cover cakes and the like such as cupcakes, mini-cakes, cookie decoration or other types of decorated treats; characterized in that the powder composition for decorative paste has the following formulation for every 1 kg: 60 to 78% of refined sugar; 10 to 20% starch; 5 to 10% fat; 1 to 5% gum; 0.1 to 0.5% of preservatives; 9 to 16% emulsifiers; 0.1 to 1% of artificial colors and aromas identical to natural; 0.1 to 1% anti-humectant; the decorative paste powder composition has a moisture content of 3% to 5%.

2. Powder composition for preparing decorative sugar paste, according to claim 1 and in a preferred option, but not limited to it, characterized in that the starch in the powder composition is corn or manioc.

3. Powder composition for preparing decorative sugar paste, according to claim 1 and in a preferred option, but not limited to it, characterized in that the fat of the powder composition is hydrogenated vegetable fat from powdered soy.

4. Powder composition for preparing decorative sugar paste, according to claim 1 and in a preferred option, but not limited to it, characterized in that the gum of the powdered composition is carboxymethylcellulose (CMC) and bovine gelatin.

5. Powder composition for preparing decorative sugar paste, according to claim 1 and in a preferred option, but not limited to it, characterized in that the preservative of the powder composition is potassium sorbate.

6. Powder composition for preparing decorative sugar paste, according to claim 1 and in a preferred option, but not limited to it, characterized in that the emulsifier of the powder composition is sodium stearoyl-2-lactyl-lactate.

7. Powder composition for preparing decorative sugar paste, according to claim 1 and in a preferred option, but not limited to it, characterized in that the anti-humectant used in the powder composition is silicon dioxide.

8. Method for obtaining sugar paste for decoration, from the powder composition of claim 1, characterized in that it comprises the following main steps:
10% increase in humidity with the addition of boiling water at a temperature of 95° to 100° C. to the weight of the powder.
first mechanical or manual mixing of the powder and water weight of step “a” to obtain a homogeneous paste.
remaining of the mixture obtained in the previous step for one hour.
second mechanical or manual mixing of the product resulting from the previous step, obtaining a smooth and homogeneous paste.
